(19) United States
(12) Patent Application Publication
(10) Pub. No.: US 2025/0356571 A1
(43) Pub. Date: Nov. 20, 2025

(54) GEOMETRY-AWARE DRIVING SCENE GENERATION

(71) Applicant: NEC Laboratories America, Inc., Princeton, NJ (US)

(72) Inventors: Ziyu Jiang, Sunnyvale, CA (US); Bingbing Zhuang, Santa Clara, CA (US); Jiacheng Chen, Coquitiam (CA)

(21) Appl. No.: 19/183,210

(22) Filed: Apr. 18, 2025

Related U.S. Application Data
(60) Provisional application No. 63/647,207, filed on May 14, 2024.
(60) Provisional application No. 63/717,344, filed on Nov. 7, 2024.
(60) Provisional application No. 63/717,345, filed on Nov. 7, 2024.
(60) Provisional application No. 63/719,712, filed on Nov. 13, 2024.

(51) Int. Cl. G06T 15/00

(52) U.S. Cl. CPC G06T 15/00

(57) ABSTRACT

Systems and methods for generating 3D scenes include a masked red, green, blue, depth (RGBD) input, which is separated into a masked RGB input and a masked depth input. The masked depth input is compressed. The masked RGB input is compressed. A high definition (HD) map control signal is generated for a depth stream, and an HD map control signal is generated for an RGB stream. A depth output is generated based on inputs from the depth stream, the HD map control signal for the depth stream, text encoder, and random sampled noise. An RGB output is generated based on inputs from the RGB stream, the HD map control signal for an RGB stream, text encoder, and random sampled noise to train a dual stream diffusion network.

### RELATED APPLICATION INFORMATION

This application claims priority to U.S. Provisional Application No. 63/647,207 filed on May 14, 2024; U.S. Provisional Application No. 63/719,712 filed on Nov. 13, 2024; U.S. Provisional Application No. 63/717,345 filed on Nov. 7, 2024; and U.S. Provisional Application No. 63/717,344 filed on Nov. 7, 2024, all incorporated herein by reference in their entirety.

This application is related to application serial number TBD (Attorney docket number 24014, entitled “3D SCENE GENERATION WITH DIFFUSION”), filed currently herewith and the application serial number TBD (Attorney docket number 24075, entitled “3D DRIVING SCENE GENERATION WITH OUTPAINTING AND INTERPOLATION”), filed currently herewith.

### BACKGROUND

### Technical Field

The present invention relates to three-dimensional scene generation and more particularly to systems and methods for generating accurate scenes for training machine vison systems.

### Description of the Related Art

Digital twin simulation is employed in verifying and scaling driving algorithms. The State-of-The-Art (SoTA) driving simulation work can be categorized to two types: Neural Radiance Field (NeRF) based, and generation-based. NeRF-based methods begin from reconstructing a driving video into 3D volume representation and then performing simulation through view rendering. While its 3D inductive bias ensures the consistency of generation content, hallucinations of unseen regions can occur.

Unseen regions are ubiquitous in driving simulations. For example, when removing a parked car from a scene, an occluded region needs to be simulated in the scene. Input format requirements are strict, and camera positions and input video needed by traditional NeRF also requires Lidar data and 3D object bounding boxes to perform driving scene reconstruction. This raises the difficulty for generating diverse and adequate simulations for extensively testing or scaling driving algorithms.

The SoTA generation-based methods include diffusion models that are a popular choice for driving scene simulations. Benefiting from the strong knowledge learned on large datasets, these methods can generate photorealistic images or frames based on text, first frames or high density (HD) maps. However, given the diffusion model is not 3D constrained, generated frames are often not geometrically consistent and physically feasible. The model may generate content against control signals, limiting its reliability.

### SUMMARY

According to an aspect of the present invention, a method for generating a three-dimensional (3D) scene includes generating a depth video based on a text description input, a high-definition (HD) map input, and an ego trajectory input wherein geometry consistency guidance is applied to enforce geometry consistency in the depth video; generating a red, green, blue (RGB) video based on the text description input, the HD map input, the ego trajectory input, and the depth video wherein geometry consistency guidance is applied to enforce geometry consistency in the RGB video; and generating a 3D scene based on the depth video, the RGB video, and the ego trajectory input.

According to another aspect of the present invention, a method for generating a simulated scene includes generating, by a first diffusion network, a first key frame based on a text description input and a high definition (HD) map input; warping the first key frame to a second viewpoint; generating, by a second diffusion network, a second key frame based on the text description input, the HD map input, and the warped first key frame; and generating, by a third diffusion network, a middle frame between the first key frame and the second key frame based on the text description input, the HD map input, and projections from the first key frame and the second key frame.

According to another aspect of the present invention, a method for generating three-dimensional (3D) scenes includes separating a masked red, green, blue, depth (RGBD) input into a masked RGB input and a masked depth input; compressing the masked depth input; compressing the masked RGB input; generating a high definition (HD) map control signal for a depth stream; generating an HD map control signal for an RGB stream; encoding a text description using a text encoder; applying random sampled noise to both the depth stream and the RGB stream; generating a depth output based on inputs from the depth stream, the HD map control signal for the depth stream, text encoder, and random sampled noise; and generating an RGB output based on inputs from the RGB stream, the HD map control signal for an RGB stream, text encoder, and random sampled noise to train a dual stream diffusion network.

According to another aspect of the present invention, a system for generating three-dimensional (3D) scenes includes a memory storing instructions and a processor configured to execute the instructions. The instruction include to separate a masked red, green, blue, depth (RGBD) input into a masked RGB input and a masked depth input; compress the masked depth input; compress the masked RGB input; generate a high definition (HD) map control signal for a depth stream; generate a HD map control signal for an RGB stream; encode a text description using a text encoder; apply random sampled noise to both the depth stream and the RGB stream; generate a depth output based on inputs from the depth stream, the HD map control signal for the depth stream, text encoder, and random sampled noise; and generate an RGB output based on inputs from the RGB stream, the HD map control signal for an RGB stream, text encoder, and random sampled noise to train a dual stream diffusion network.

A non-transitory computer-readable medium stores instructions that, when executed by a processor, cause the processor to perform a method. The method includes separating a masked red, green, blue, depth (RGBD) input into a masked RGB input and a masked depth input; compressing the masked depth input; compressing the masked RGB input; generating a high definition (HD) map control signal for a depth stream; generating a HD map control signal for an RGB stream; encoding a text description using a text encoder; applying random sampled noise to both the depth stream and the RGB stream; generating a depth output based on inputs from the depth stream, the HD map control signal for the depth stream, text encoder, and random sampled noise; and generating an RGB output based on inputs from the RGB stream, the HD map control signal for an RGB stream, text encoder, and random sampled noise to train a dual stream diffusion network.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram illustrating a video or image simulation system/method that employs a text description input, in accordance with an embodiment of the present invention;

FIG. 2 is a block/flow diagram illustrating a framework composed of a key frame generation stage and an interpolation stage for generating 3D scenes in accordance with an embodiment of the present invention;

FIG. 3 is a block/flow diagram illustrating a system/method for training an RGBD diffusion model and using the trained model for autoregressive outpainting and interpolation in accordance with an embodiment of the present invention;

FIG. 4 is a block/flow diagram illustrating an autoregressive outpainting and interpolation process using trained diffusion networks to generate key frames and middle frames in accordance with an embodiment of the present invention;

FIG. 5 is a block/flow diagram illustrating a joint RGBD diffusion network architecture that combines RGB and depth information in accordance with an embodiment of the present invention;

FIG. 6 is a block/flow diagram illustrating a dual stream diffusion network architecture that processes RGB and depth separately, in accordance with an embodiment of the present invention;

FIG. 7 is a block/flow diagram illustrating an RGBD diffusion network training framework, in accordance with an embodiment of the present invention;

FIG. 8 is a block/flow diagram illustrating an exemplary processing system for implementing aspects of the present invention;

FIG. 9 is a diagram illustrating an autonomous driving system employing computer vision for object detection and avoidance, in accordance with an embodiment of the present invention;

FIG. 10 shows an example of a synthesized image generated, comparing a reference image to a synthesized image, in accordance with an embodiment of the present invention;

FIG. 11 is a flow diagram illustrating a method for generating a three-dimensional (3D) scene, in accordance with an embodiment of the present invention;

FIG. 12 is a flow diagram illustrating another method for generating a simulated scene, in accordance with an embodiment of the present invention; and

FIG. 13 is a flow diagram illustrating a method for generating a three-dimensional (3D) scene using a dual stream diffusion network.

### DETAILED DESCRIPTION OF PREFERRED EMBODIMENTS

In accordance with embodiments of the present invention, systems and methods are provided for image simulation. Neural radiance field (NeRF) can be employed for 3D reconstruction of images for captured scenes and view synthesis. Simulation of image data is needed for the training and verification of modern autonomous driving systems. As a part of traffic, the simulation of vehicles is a component for a complete simulation system. In accordance with embodiments of the present invention, 3D object assets are automatically created from real driving data without manual effort, leading to a low-cost and scalable system for wide deployment.

Simulation for autonomous driving systems can significantly mitigate the need for training data and on-road testing, thus facilitating the progression of the autonomous driving technologies. Within the simulation framework, appearance simulation ensures realism for the rendered images. Conventional NeRF methodologies fail to handle the autonomous driving scene, especially in the context of sky and dynamic objects. The challenge in accurately encoding the sky arises from rays never intersecting with any opaque surface of the sky. Moreover, the texture of the sky is often perceived as simple due to its frequent presentation of vast, uninterrupted expanses of color, such as the serene and unblemished blue observed on a clear day. These factors cause the difficulty for NeRF in modelling the correct geometric information of sky and consequently degrade the performance. Another challenge that NeRF encounters is that NeRF is designed for encoding static objects rather than dynamic objects, leading to difficulty in accurately representing the dynamic cars in the scene. Given that self-driving vehicles are often equipped with Lidar in addition to cameras, as well as the existence of high-definition (HD) maps collected for localization and navigation purposes. HD maps encode semantic information. Diffusion models and generative models that learn to transform noise into data samples by progressively reversing a diffusion process, often used for image generation and other computer vision tasks.

In accordance with embodiments of the present invention, the strength of both NeRF and diffusion are leveraged to provide street scene generation methods where object simulation can be done with methods like Zero-1-to-3 to focus on 3D scene generation. Driving scene simulation advances autonomous vehicle research and development by providing a controlled and flexible environment for testing. The driving scene simulation facilitates fast and scalable evaluation of complex driving scenarios, edge cases, and safety-critical situations, without the inherent risks or costs of real-world testing, thereby enabling rapid iteration and system refinement.

In accordance with embodiments of the present invention, a framework is provided to address the challenges of long-horizon 3D consistent driving scene generation by leveraging geometry awareness. In an embodiment, a key frame generation stage and an interpolation stage are employed. The framework begins by generating the appearance and geometry of multiple key frames to anchor the global appearance of the driving scene. Subsequently, the interpolation stage fills in the frames between neighboring key frames.

Both the key frame generation and interpolation stages leverage geometry awareness to produce high-quality, 3D-consistent content. Geometry awareness is incorporated at three distinct levels. Strong geometric prior knowledge is integrated into the key frame generation by pretraining on large-scale explicit depth data. Next, the generation process is conditioned on explicit geometry data, such as sparse point cloud rendering, which guides both the key frame generation and interpolation stages. Then, geometry-consistent guidance is employed to further enhance the model's understanding of geometric relationships. Therefore, the framework generated long-horizon, 3D-consistent driving scenes by incorporating geometric information at three distinct levels to enhance scene consistency and quality. The methods generate long-horizon scenes with video lengths exceeding 20 seconds, achieving high generation quality on a NuScenes benchmark.

World generation can be generated due to comprehensive priors learned from extensive datasets. However, the absence of a 3D inductive bias within a diffusion model frequently leads to generated content that lacks geometric consistency and physical plausibility. The 3D scene generation method in accordance with the present embodiments integrates 3D geometric inductive biases into the diffusion processes. The present methods utilize rich priors learned by the diffusion model to first generate high-quality depth videos, which subsequently serve as the condition for generating color (e.g., red, green, blue (RGB)) videos. A geometry guidance mechanism is introduced that enforces geometric consistency across both the depth and red, green, blue (RGB) videos diffusion processes. NeRF translates the generated depth and RGB videos into 3D to provide a high-performance 3D world simulation and diffusion.

In the pipeline of the present system, the diffusion model is repurposed to generate depth videos. Then, RGB videos are generated conditioned on the generated depth videos. Then, a NeRF model is employed to construct the 3D scene based on the generated depth and RGB videos. To further enhance the consistency for both generated depth and RGB videos, geometry guidance is provided.

For the depth generation, a pre-trained diffusion model is repurposed to generate the depth videos. To better utilize the pre-trained knowledge, the depth image is formatted like RGB images by first normalizing the color to 0-255. Then, a single channel depth image is repeated three times to a 3-channel image. This format shares similar appearance and structure (like edges and object shape) as RGB images, decreasing the domain gap in the repurposing fine-tuning and therefore leads to better performance.

In terms of the model, the structure of, e.g., magicDrive-t can be adopted as the diffusion framework given its high quality in video generation. The structure takes an HD map and text as input and generates a sequence of frames as output. Even though cross-frame attention has been adopted in its framework, the scene can still suffer from the lack of 3D consistency. To address this, geometry consistent guidance is introduced. Due to the depth representation, any generated depth map f_{A} in frame A can be warped to a difficult frame B as f_{A}^{B}. When the generated depth is 3D consistent, f_{A}^{B} should be the same as generated depth map f_{A}^{B} in frame B. Therefore, 12 loss between f_{A}^{B} and f_{B} can be employed in the diffusion process as a guidance loss to enhance the consistency. In practice, each frame is warped to its previous frame and the guidance loss is computed.

In video generation, the depth video is added as a new condition to the magicDrive-t model to generate color (e.g., RGB) videos aligning with depth. Similarly, the generated RGB videos may fail to be consistent even though depth maps have been used as a condition. Given the depth of these images, the geometry consistent guidance can be applied by warping the RGB images to constrain the consistency.

Combining these techniques, the present embodiments are able to generate 3D consistent scenes with only text and HD map inputs. Compared to NeRF based methods, the present embodiments dramatically decrease the input requirement with significantly higher hallucination resistance, and compared to diffusion methods, physical feasible 3D scenes are generated.

The present invention includes a 3D-consistent scene generation pipeline with geometry consistent guidance. The present invention addresses 3D scene generation by concurrently leveraging NeRF and diffusion.

Autonomous simulation provides a safe and cost-effective means for testing autonomous systems within virtual environments. High-quality scene simulation is needed for creating realistic driving scenarios, supporting accurate sensor perception, and generating effective training data. A framework for long-horizon scene generation includes key frame generation and interpolation. Key frame generation anchors global appearance and geometry by autoregressively producing 3D-consistent keyframes, while the interpolation stage fills in the gaps by generating dense frames conditioned on these keyframes. The framework integrates geometry awareness using prior knowledge, conditioning, and guidance, each contributing to enhanced 3D consistency and generation quality across a long temporal span. Experimental results demonstrate that the present embodiments achieve performance improvements in generating realistic, geometrically consistent scenes for driving simulation, making it a robust tool for autonomous scene generation.

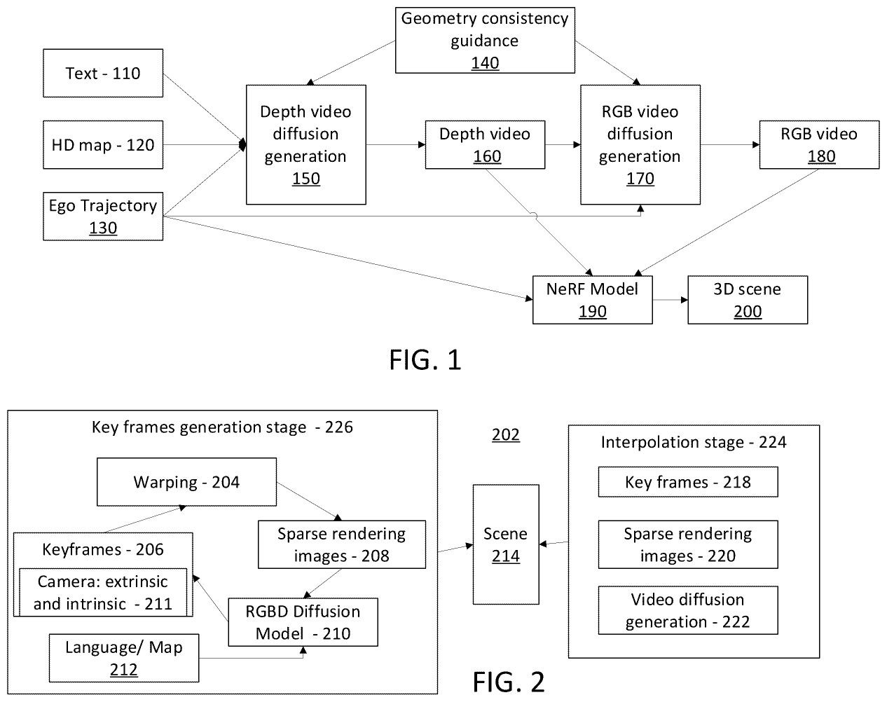

Referring now in detail to the figures in which like numerals represent the same or similar elements and initially to FIG. 1, a high-level block diagram shows a video or image simulation system/method that employes a text description input in accordance with an embodiment of the present invention. In block 110, the system takes a text description as input (e.g., “generate a scene with a red car . . . ”). In block 120, an HD map can also be taken as an input. In block 130, an ego trajectory can also be taken as an input.

The ego trajectory is a planned or predicted path of movement for a vehicle or autonomous system over time. An ego trajectory may include information such as the expected position, orientation, velocity, and acceleration of the vehicle at various points along its projected route. This trajectory information may be used for motion planning, obstacle avoidance, and coordinating the vehicle's movements within its environment.

In block 140, geometry consistency guidance is employed to enforce the geometry consistency in block 150 and block 170.

Geometry consistent guidance can include one or more techniques used in the 3D scene generation process to ensure that the generated depth and red, green, blue (RGB) videos maintain geometric consistency across frames. This approach can include warping. The depth information from one frame may be used to warp the content to adjacent frames. This warping process helps maintain spatial consistency between frames. A loss function may be employed to measure and minimize the discrepancy between the warped content and the generated content in overlapping regions. This encourages the model to produce geometrically consistent outputs. Cross-frame attention can be employed where the generation process may incorporate information from multiple frames simultaneously, allowing the model to consider spatial relationships across time. Depth-aware constraints can also provide guidance by enforcing constraints based on the depth information to ensure that objects maintain proper relative positions and scales across frames. 3D-aware generation may incorporate 3D geometric priors or explicit 3D representations to guide the generation of both depth and RGB content in a spatially consistent manner.

By applying geometry consistent guidance, the system may produce more coherent and realistic 3D scenes, with improved spatial and temporal consistency between generated frames. This can be particularly important for applications such as autonomous driving simulations, where accurate representation of spatial relationships is crucial.

Block 150 includes depth video diffusion generation. This includes taking inputs from blocks 110, 120 and 130 and generating a depth video in block 160. Any video diffusion model can be employed in block 160. For example, a magicDrive-t model can be employed. The model is repurposed by fine-tuning on depth videos. The diffusion process is guided by geometry consistency guidance in block 140 to ensure consistency.

In block 160, the depth video is the output of block 150 and serves as an input for block 170. Block 170 includes RGB video diffusion generation. Block 170 takes inputs from blocks 110, 120, 130 and 160 to generate an RGB video in block 180. In block 170, any video diffusion model can be employed (e.g., magicDrive-t). An additional depth constraint and fine-tuning can be added on the RGB video(s) of block 180. The diffusion process is guided by block 140 to ensure consistency.

In block 180, the RGB video is generated. This is the output of block 170, which serves as input for block 190. In block 190, a NeRF model is generated by employing input from blocks 130, 160 and 180. Any driving scene NeRF can be used for this module (like Unisim). A 3D scene is output from the system in block 200, which is a 3D scene in a NeRF representation.

The present embodiment includes a generation framework that is initialized with the diffusion models, which are a robust class of generative models capable of capturing complex data distributions through iterative denoising processes. A core mechanism involves a forward diffusion process q(xₜ|xₜ₋₁) that incrementally adds Gaussian noise to the data over T timesteps, transforming an original data sample x₀ into a noisy latent representation x_{T}. This process is mathematically defined as:

$$q ( {x}_{t} \vert {x}_{t - 1} ) = 𝒩 ( {x}_{t - 1} ; \sqrt{1 - {β}_{t}} {x}_{t - 1} , {β}_{t} I ) \qquad ( 1 )$$

where βₜ denotes the variance schedule controlling the noise level at each timestep, and I is the identity matrix. The reverse diffusion process aims to recover the original data by learning a parameterized denoising model:

$${p}_{θ} ( {x}_{t} \vert {x}_{t - 1} ) = 𝒩 ( {x}_{t - 1} ; {μ}_{ϑ} ( {x}_{t} , t ) , {\sum }_{θ} ( {x}_{t} , t ) ) \qquad ( 2 )$$

with μ_{θ} and Σ_{θ} representing the mean and covariance functions modeled by neural networks with parameters θ. By iteratively applying this reverse process starting from Gaussian noise x_{T}, the model generates new data samples x₀ that resemble the training data distribution.

Latent Diffusion Models (LDMs) extend this framework by operating within a compressed latent space rather than the high-dimensional data space. This design is followed for enhancing computational efficiency without compromising generative performance.

Referring to FIG. 2, a framework 202 is composed of two stages. A key frame generation stage 226 and an interpolation stage 224. For key frame generation, a sparse list of viewpoints is sampled in sparse rendering images 208 with a certain distance between each viewpoint. An appearance and geometry of key frames 206 is generated. The generated key frames 206 anchor the appearance of a global scene. With the generated key frames 206, an interpolation is performed between each pair of the key frames 206 to generate the missing points.

The key frame generation stage 226 commences with the selection of multiple key frames 206 along a trajectory path. Generation starts from one endpoint of these key frames 206 and progresses autoregressively toward an opposite endpoint. At the first key frame, the process starts with either a generated or sampled RGBD frame from an RGBD diffusion model 210, which is subsequently back-projected to form colored 3D point clouds, denoted as P. The generation of subsequent key frames involves projecting P onto a 2D image plane as sparse RGBD rendering, represented by h, with camera parameters. The RGBD diffusion model 210 then utilizes h, along with optional language and map conditions from block 212 to generate both appearance and geometry of a new key frame 206. The new key frame 206 is subsequently back-projected to form a colored 3D point cloud and incorporated into P. This procedure iterates until all key frames along the trajectory are generated.

Selecting an optimal spacing for key frames is an important aspect. On one hand, overly dense key frames result in inefficient generation and can degrade performance, as generating meaningful content in small editable regions is challenging. Conversely, if the key frames are too sparse, the interpolation stage 224 may fail. In an illustrative implementation, the first key frame can be designated as one endpoint of the trajectory, then traverse the trajectory to identify the subsequent key frame. The first viewpoint where either the distance or the view angle difference from the previous key frame exceeds β or γ, respectively, is selected as the next key frame. In one example, we set β=10 m and γ=20 degrees.

To improve the geometry awareness of a model, instead of employing a standard RGB diffusion network, an adopted RGBD diffusion network is employed. This introduces strong geometric priors by explicitly modeling depth information through training with ground truth depth data. Meanwhile, it also allows explicit conditioned generation on both appearance and geometry.

The RGBD diffusion model 210 (or network) is based on the Latent Diffusion Models (LDMs), having a Variational Autoencoder (VAE) that compresses images into a latent space and a U-Net that performs diffusion within this latent space. To accommodate depth generation, the VAE to support depth encoding and decoding is modified, while preserving the latent code shape. Specifically, depth is concatenated (1 channel) with RGB (3 channels) to create a 4-channel RGBD input for the VAE. Architecturally, first and last convolutions are extended in both the encoder and decoder to accommodate this 4-channel input and output, ensuring compatibility with RGBD data. 16-bit precision is employed for RGBD inputs and outputs to retain depth details accurately. Since the latent feature shape remains unchanged, the existing U-Net architecture can be applied directly for latent diffusion.

The RGBD VAE is initialized with a pretrained RGB VAE. The added parameters are set as zero to preserve pretrained knowledge. The optimization target is defined as:

$${ℒ}_{VAE} = {𝔼}_{q ϕ ( z \vert x )} [ - {log}_{{p}_{θ}} ( {x}_{rgb} \vert z ) ] + {λ}_{depth} \cdot {𝔼}_{q ϕ ( z \vert x )} [ - {log}_{{p}_{θ}} ( {x}_{depth} \vert z ) ] + {𝒟}_{KL} ( {q}_{ϕ} ( z \vert x ) ‖ p ( z ) ) \qquad ( 3 )$$

where x_{rgb} represents the RGB image data, and x_{depth} represents the depth map data. x is the combination of x_{rgb} and x_{depth}. q_{ϕ}(z|x_{rgb}, x_{depth}) is the encoder network with parameters ϕ, encoding both RGB and depth inputs. p_{θ}(x_{rgb}|z) and p_{θ}(x_{depth}|z) are the decoder networks reconstructing RGB images and depth maps from the latent variable z. D_{KL} is the Kullback-Leibler divergence between the approximate posterior q_{ϕ}(z|x) and the prior p(z).

The first term, [symbol] _{qϕ(z|x)}[−logₚ_{_{θ}}(x_{rgb}|z)] and the second term, [symbol] _{qϕ(z|x)}[−logₚ_{_{θ}}(x_{depth}|z)], minimize the reconstruction errors for the RGB images and depth maps, respectively. The third term [symbol] _{KL} (q_{ϕ}(z|x)∥p(z)), regularizes the latent space by enforcing alignment with a predefined prior distribution, thereby promoting smoothness and continuity in the latent space z.

Given that depth maps tend to contain less high frequency information than RGB images due to the inherently smooth nature of geometric data, the reconstruction loss for depth is generally smaller than for RGB. To address this imbalance, a weighting factor, λ_{depth}, is introduced to amplify the depth reconstruction loss. λ_{depth} can be, e.g., equal to 10.

Sparse rendering conditions ensure that the generated key frames are 3D-consistent with existing key frames, which is important in the auto-regressive key frame generation process that generates sparse rendering images 208 and 220. To achieve this consistency, we first back-project the pixels of all key frames into 3D space using the generated RGBD images and the associated camera information. This process is formalized as:

$$P = B ( {𝒳}_{rgb} , {𝒳}_{depth} , 𝒞 ) \qquad ( 4 )$$

where

$$P = {\{ {P}_{i} \}}_{i = 1}^{N}$$

denotes the set of 3D point clouds reconstructed from the key frames;

$${𝒳}_{rgb} = {\{ {x}_{rgb , i} \}}_{i = 1}^{N} and {𝒳}_{depth} = {\{ {x}_{depth , i} \}}_{i = 1}^{N}$$

represent the collections of RGB images and depth images of the key frames, respectively;

$$𝒞 = {\{ {c}_{i} \}}_{i = 1}^{N}$$

is the set of camera parameters 211 (including intrinsic and extrinsic parameters) corresponding to each key frame; B(·) is the back-projection function that reconstructs the 3D point clouds P from the RGB and depth images using the camera parameters cᵢ for each key frame i.

Subsequently, a conditioning signal is generated by projecting the point clouds onto the target image plane, formulated as:

$$h , {m}_{v} = ℛ ( P , c ) \qquad ( 5 )$$

where h is the rendered RGBD image in the target view; mᵥ, is the corresponding visibility mask indicating the presence of projected points; P is the set of 3D point clouds obtained from the previous step; c denotes the camera parameters of the target view; [symbol] (·) is the rendering function that projects the 3D point clouds onto the image plane defined by the target camera parameters c.

To incorporate this conditioning into the RGBD diffusion model 210, an architecture similar to the Stable Diffusion inpainting network can be adopted. Specifically, the projected RGBD image h is first encoded into a latent code using the RGBD VAE, serving as an additional conditioning input to the model. Additionally, the mask mᵥ, indicating the presence of point cloud data, is downsampled and used as input. The latent code to denoise, the mask mᵥ, and the conditioned latent code h are concatenated together and fed into the U-Net. To accommodate the additional channels introduced by this concatenation (which includes the RGBD channels and the mask), the U-Net architecture is extended by adding, e.g., five extra input channels.

By integrating the projected RGBD information and the visibility mask into the diffusion process, the model can effectively capture the existing appearance and 3D geometric, ensuring that the generated key frames maintain coherence with existing frames, thereby enhancing the overall quality and realism of the auto-regressive generation process.

Map and bounding box (bbox) conditions are considered. Maps and dynamic actors such as cars and pedestrians play a role in driving scene simulation. To support controllability over both the map and the actors, the RGBD diffusion model 210 can be augmented with a ControlNet branch. To control the actors, bbox conditions are employed. We utilize two types of bbox control images: semantic bbox control and orientation bbox control. Both bbox controls are generated by projecting 3D bounding boxes onto the camera plane. In the semantic bbox control, different colors can be used to distinguish vehicles, pedestrians, roadblocks, etc. Additionally, the orientation of vehicles is indicated by assigning unique colors to each edge of the vehicle.

In block 204, warp-consistent guidance or warping is performed. Although RGBD diffusion models 210 conditioned on sparse rendering images 208, 220 share similarities with traditional image inpainting tasks, the generated content frequently exhibits more pronounced inconsistencies in the overlapping regions compared to inpainting. This is primarily due to the misalignment between the sparse rendering and the ground truth RGBD generation used during training.

Inconsistent generation adversely affects 3D consistency, leading to noticeable shifts in appearance. To mitigate this, a projection consistency loss is introduced to quantify the discrepancy between sparse rendering and RGBD generation. Specifically, this projection consistency loss is defined as the masked Mean Squared Error (MSE) between the predicted RGBD x and the sparse rendering input h, formulated as:

$${ℒ}_{( x , h ; m )} = \frac{{\sum }_{i} {{m}_{i} ( {x}_{i} - {h}_{i} )}^{2}}{{\sum }_{i} {m}_{i}} \qquad ( 6 )$$

where xᵢ and hᵢ represent the i-th pixels of the predicted RGBD x and the sparse rendering input h, respectively. Here, mᵢ∈{0, 1} is the i-th pixel of the overlap mask m. The overlap mask m is defined as the intersection of the visibility mask of the projected point clouds, mᵥ, (Equation 8) and mₛ, where mₛ denotes the area of that is visible from the perspective of existing keyframe cameras [symbol] . Including mₛ effectively removes occlusion artifacts from the final result.

The gradient of [symbol] _{d} is then utilized to steer the generation towards regions in the data space that are more consistent with the sparse rendering. Formally, let pθ(xₜ|t) be the diffusion model at timestep t. The sampling process is modified by adjusting the original score estimate s_{θ}(xₜ, t) with the gradient of the [symbol] _{d} with respect to xₜ. The adjusted score function is defined as:

$${\tilde{s}}_{θ} ( {x}_{t} , t ) = {s}_{θ} ( {x}_{t} , t ) + w {∇}_{xt} {ℒ}_{d} ( {x}_{t} , h ; m ) \qquad ( 7 )$$

where (xₜ, t) is the guided score function used for sampling, s_{θ}(xₜ, t) is the original score estimated by the diffusion model, w is the guidance scale that controls the influence of the loss on the sampling process, ∇ₓₜ [symbol] _{d}(xₜ, h; m) is the gradient of [symbol] _{d} with respect to the noisy input xₜ.

This warp-consistent guidance in block 204 significantly improves consistency between the sparse rendering and the generated keyframe, thereby enhancing the 3D coherence of the generated frames.

The interpolation stage 224 focuses on generating dense frames based on sparse key frame conditions. To achieve this, the system begins by rendering sparse frames in sparse rendering images 220 for each interpolation view's camera as the geometric condition, defined as follows:

$${h}^{i} , {m}^{i} = ℛ ( P , {c}^{i} ) \qquad ( 8 )$$

where hⁱ is the rendered RGBD image for the interpolation view, mⁱ is the corresponding visibility mask indicating the presence of projected points, P is the set of 3D point clouds obtained from the key frames, cⁱ denotes the camera parameters of the interpolation views, and [symbol] (·) is the rendering function that projects the 3D point clouds onto the image plane defined by the target camera parameters c.

To inpaint missing pixels in the rendered outputs, a video diffusion model is adapted for video diffusion generation in block 222. This video diffusion generation process can be defined as follows:

$${\{ {x}_{t}^{i} \}}_{i = 1}^{T} = G ( {\{ {z}_{t} \}}_{i = 1}^{T} ; {\{ {h}_{t}^{i} \}}_{i = 1}^{T} , K ) \qquad ( 9 )$$

where each zₜ is sampled from standard normal distribution [symbol] (0, I);

$${\{ {x}_{t}^{i} \}}_{i = 1}^{T}$$

indicates the frames to interpolate.

$${\{ {h}_{t}^{i} \}}_{i = 1}^{T}$$

are the corresponding sparse rendering frames. K refers to the key frames. G represents the video diffusion model.

An advantage of employing a video diffusion network is its ability to foster smooth and consistent frame generation by allowing temporal attention between frames. Furthermore, the video diffusion model inherently learns strong consistency priors through training on large-scale video datasets, which enhances its performance in generating cohesive results.

RGBD Diffusion Model Training: training a model in accordance with the present embodiments can be split into two different stages: RGBD pretraining and Rendering Conditioned Training. In the RGBD pre-training stage, we adopt the pre-trained Stable Diffusion model to generate RGBD content. Afterwards, we introduce the sparse rendering, map and bbox conditions for the Rendering Condition Training.

RGBD pre-training: The purpose of RGBD pre-training is for scaling the diffusion model on a large scale RGBD dataset to learn strong geometry priors. While there are many existing datasets for RGB images, the depth ground truth is often scarce. To train the RGBD diffusion network in large scale, we generate the depth and Metric3d v2. In practice, the RGB images can be collected from dataset such as, e.g., Nuscene, Argoverse, SA-1B, etc. for generating the depth, forming a dataset with, e.g., 13 million diverse images. In an embodiment, we used the ground truth intrinsics for Metric3d v2 on Nuscene and Argoverse, while predicting the intrinsics with WildCamera on SA-1B. We also generated text pseudo-labels with a Vision Language Model (VLM) for pretraining.

A diffusion Unet can be initialized with a pre-trained Unet of, e.g., SD-Inpaint-V2.0. The model is trained with a text conditioned inpainting task for RGBD for preserving text controllability and inpainting ability of the diffusion model. The inpainting masks are randomly sampled from visibility mask of point clouds projection mᵥ.

A Unet includes a convolutional neural network architecture that may include a contracting path to capture context and a symmetric expanding path that enables precise localization. The Unet can be characterized by its U-shaped architecture, where the network's layers are arranged in a U-shape when visualized. The Unet may include skip connections between the contracting and expanding paths, which allow the network to propagate context information to higher resolution layers. The Unet architecture is adapted for various image processing tasks, such as, e.g., image generation, denoising, or super-resolution. Unet may be employed in diffusion models to process latent representations and generate high-quality images or other data types.

For the sparse Rendering Condition Training, a training strategy can be devised to mimic the iterative key frames generation process. Specifically, each training sample is generated via sampling a pair of frames from the same video sequence with a gap range from 5-60 frames. Assigning one of the frames to be a condition frame and the other one as a target frame, we then project the condition frame to the target frame utilizing the camera information and depth. The projection serves as the sparse rendering condition input for target frame, conditioning the model generation with the map and bbox. In an embodiment, we perform the above data generation on Nu-scenes, generating 500 samples for each scene, resulting in a dataset with, e.g., 350k samples.

However, the generated conditions are sometimes inconsistent due to depth noise, dynamic objects and occlusions. This can greatly impact the 3D consistency of the iterative generation. To address this, the warp consistent loss [symbol] _{d}(x, h; m) is applied to measure the inconsistency of training sampling and filter out the most inconsistent samples. In one example, we filter out 20% of 350k samples and only train with 280k samples.

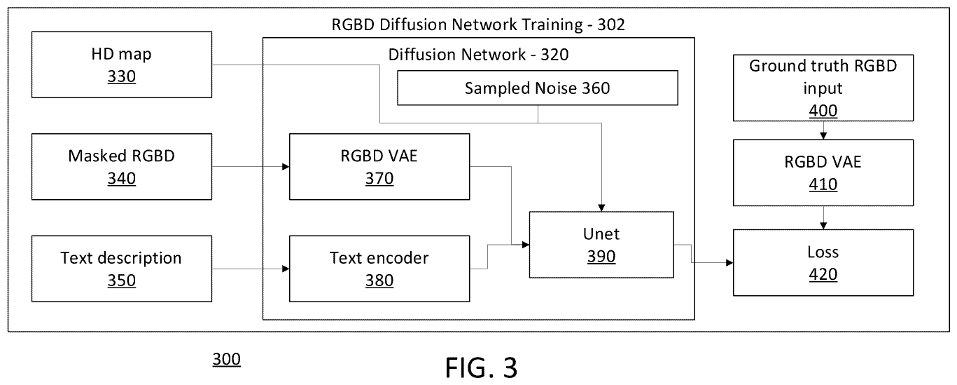

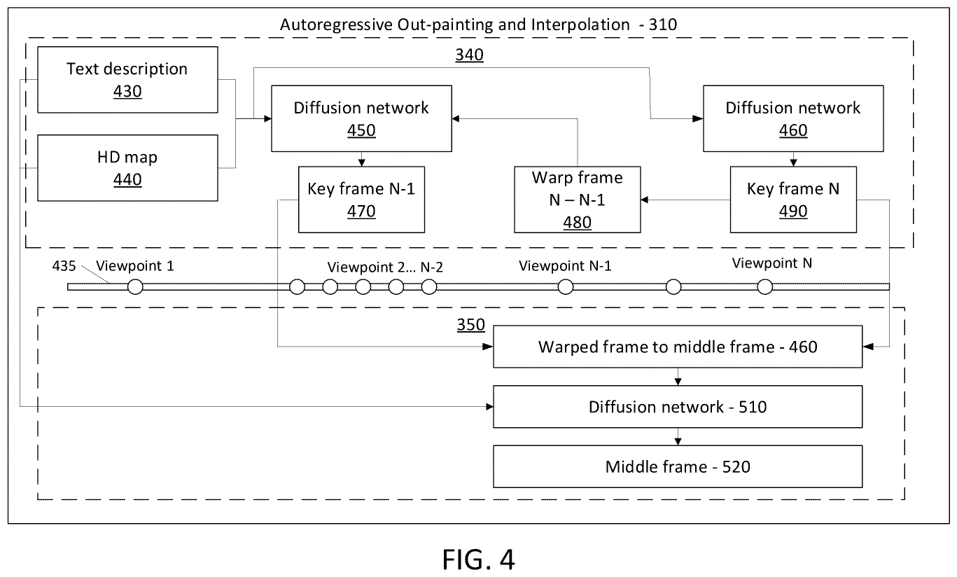

Referring to FIG. 3, a system/method 300 shows a training stage 302 in accordance with embodiments of the present invention. The training stage 302 provides an RGBD Diffusion Network 320 for training an RGBD diffusion model. The RGBD diffusion model will be employed in generating accurate simulated scenes for training autonomous vehicle systems. An autoregressive outpainting and interpolation stage of the diffusion model 310 (FIG. 4) includes a framework for generating videos utilizing the RGBD diffusion model.

The diffusion network 320 includes a network structure having random sampled noise 360, an RGBD Variational Autoencoder (VAE) 370, a text encoder 380, a Unet 390. The diffusion network 320 shares the same structure and weight as blocks 450, 460 and 500 in the autoregressive outpainting and interpolation stage of the diffusion model 310 (FIG. 4).

The inputs for training the diffusion model include an HD map 330. The diffusion model takes HD map as control signal. A masked RGBD input 340 is another input. The diffusion model also takes the masked RGBD input 340 as a control signal. A text description 350 is included as another input to the diffusion model.

Input from the HD map 330 is mixed with random sampled noise 360. The random sampled noise 360 can be sampled, e.g., from a gaussian distribution. Then, the Unet 390 takes the HD map 330 with the random sampled noise 360 at a start of a diffusion process. In addition, the RGBD VAE 370 receives the masked RGBD input 340. The RGBD VAE 370 compresses the masked RGBD input 340, which is a concatenation of RGB images and their depth map. Further, a text encoder 380 encodes the text description 350. The text encoder 380 can include, e.g., a CLIP encoder. The generated features of the RGBD VAE 370 and the text encoder 380 are also input to the Unet 390.

The Unet 390 takes inputs from the HD map 330 with the random sampled noise 360, the RGBD VAE 370 and the text encoder 380 and outputs a generated latent feature for computing loss 420. A ground truth RGBD input 400 includes a ground truth image or information to enable comparison and evaluation of loss for feedback. The ground truth RGBD input 400 is employed for training a diffusion model 310 (FIG. 4). The ground truth RGBD input 400 is input to the RGBD VAE 410. The RGBD VAE 410 can be the same or different than the one employed for the RGBD VAE 370. The RGBD VAE 410 compresses the ground truth RGBD input 400 so that the structure and weight are the same as or compatible with the output of the RGBD VAE 370.

The loss 420 is employed to supervise the training of diffusion model 310. In an embodiment, 12 loss can be employed.

Computation of losses, training models and forward and backward propagation refer to operations employing neural networks. After collecting the data, model training (e.g., diffusion models) occurs using the data collected. The model training includes training, e.g., an initial perception model. The perception model can include sensor fusion data, which merges data from at least two sensors or data sources. Perception refers to the processing and interpretation of sensor data including images to detect, identify, track and classify objects. Sensor fusion and perception enable, e.g., an automated driver assistance system (ADAS) to develop a 2D or 3D model of the surrounding environment that feeds into a control unit for a vehicle. Other applications can include inspection machines in a manufacturing environment, computer visions, cyber security applications, etc. The perception model can also include bird's eye view (BEV) perspectives as trajectory predictions. Trajectory prediction includes information for predicting spatial coordinates of various vehicles or objects, e.g., cars, pedestrians, etc.

As employed herein, multilayer perceptrons (MLPs) have been described to provide a feedforward artificial neural network, consisting of fully connected neurons to distinguish data. While MLPs are described, other artificial machine learning systems can also be employed in accordance with embodiments of the present invention to predict outputs or outcomes based on input data, e.g., image data. In an example, given a set of input data, a machine learning system can predict an outcome. The machine learning system will likely have been trained on much training data in order to generate its model. It will then predict the outcome based on the model.

In some embodiments, the artificial machine learning system includes an artificial neural network (ANN). One element of ANNs is the structure of the information processing system, which includes a large number of highly interconnected processing elements (called “neurons”) working in parallel to solve specific problems. ANNs are furthermore trained using a set of training data, with learning that involves adjustments to weights that exist between the neurons. An ANN is configured for a specific application, such as pattern recognition or data classification, through such a learning process.

The present embodiments may take any appropriate form, including any number of layers and any pattern or patterns of connections therebetween. ANNs demonstrate an ability to derive meaning from complicated or imprecise data and can be used to extract patterns and detect trends that are too complex to be detected by humans or other computer-based systems. The structure of a neural network is known generally to have input neurons that provide information to one or more “hidden” neurons. Connections between the input neurons and hidden neurons are weighted, and these weighted inputs are then processed by the hidden neurons according to some function in the hidden neurons. There can be any number of layers of hidden neurons, and as well as neurons that perform different functions. There exist different neural network structures as well, such as a convolutional neural network, a maxout network, etc., which may vary according to the structure and function of the hidden layers, as well as the pattern of weights between the layers. The individual layers may perform particular functions, and may include convolutional layers, pooling layers, fully connected layers, softmax layers, or any other appropriate type of neural network layer. A set of output neurons accepts and processes weighted input from the last set of hidden neurons.

This represents a “feed-forward” computation, where information propagates from input neurons to the output neurons. Upon completion of a feed-forward computation, the output is compared to a desired output available from training data. The error relative to the training data is then processed in “backpropagation” computation, where the hidden neurons and input neurons receive information regarding the error propagating backward from the output neurons. Once the backward error propagation has been completed, weight updates are performed, with the weighted connections being updated to account for the received error. It should be noted that the three modes of operation, feed forward, back propagation, and weight update, do not overlap with one another. This represents just one variety of ANN computation, and that any appropriate form of computation may be used instead. In the present case the output neurons provide emission information for a given plot of land provided from the input of satellite or other image data.

To train an ANN, training data can be divided into a training set and a testing set. The training data includes pairs of an input and a known output. During training, the inputs of the training set are fed into the ANN using feed-forward propagation. After each input, the output of the ANN is compared to the respective known output or target. Discrepancies between the output of the ANN and the known output that is associated with that particular input are used to generate an error value, which may be backpropagated through the ANN, after which the weight values of the ANN may be updated. This process continues until the pairs in the training set are exhausted.

After the training has been completed, the ANN may be tested against the testing set or target, to ensure that the training has not resulted in overfitting. If the ANN can generalize to new inputs, beyond those which it was already trained on, then it is ready for use. If the ANN does not accurately reproduce the known outputs of the testing set, then additional training data may be needed, or hyperparameters of the ANN may need to be adjusted.

ANNs may be implemented in software, hardware, or a combination of the two. For example, each weight may be characterized as a weight value that is stored in a computer memory, and the activation function of each neuron may be implemented by a computer processor. The weight value may store any appropriate data value, such as a real number, a binary value, or a value selected from a fixed number of possibilities, which is multiplied against the relevant neuron outputs. Alternatively, the weights may be implemented as resistive processing units (RPUs), generating a predictable current output when an input voltage is applied in accordance with a settable resistance.

A neural network becomes trained by exposure to empirical data. During training, the neural network stores and adjusts a plurality of weights that are applied to the incoming empirical data. By applying the adjusted weights to the data, the data can be identified as belonging to a particular predefined class from a set of classes or a probability that the input data belongs to each of the classes can be output.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types and may include multiple distinct values. The network can have one input node for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

A deep neural network can have an input layer of source nodes, one or more computation layer(s) having one or more computation nodes, and an output layer, where there is a single output node for each possible category into which the input example could be classified. An input layer can have a number of source nodes equal to the number of data values in the input data. The computation nodes in the computation layer(s) can also be referred to as hidden layers because they are between the source nodes and output node(s) and are not directly observed. Each node in a computation layer generates a linear combination of weighted values from the values output from the nodes in a previous layer, and applies a non-linear activation function that is differentiable over the range of the linear combination. The weights applied to the value from each previous node can be denoted, for example, by w₁, w₂, . . . wₙ₋₁, wₙ. The output layer provides the overall response of the network to the input data. A deep neural network can be fully connected, where each node in a computational layer is connected to all other nodes in the previous layer, or may have other configurations of connections between layers. If links between nodes are missing, the network is referred to as partially connected.

Referring to FIG. 4, once trained as described in FIG. 3, the diffusion model 310 is ready to simulate scenes. The simulation includes an outpainting framework 540, and an interpolating framework 550. The outpainting framework 540 generates key frames or viewpoints from N to 1. The generation process from N to N−1 is illustrated in FIG. 4. The same process would be applied recursively from viewpoint N−1 to 1. The interpolating framework 550 provides an interpolation process to generate the frames between any two adjacent key frames. The interpolation for a middle frame 520 between viewpoints N and N−1 is illustratively shown. Other middle frames can also be generated with similar methods.

Image generation or simulation can include a text description input 430. The diffusion model 310 takes the text description as one input. The diffusion model 310 takes an HD map 440 as another input.

A diffusion network 450 generates Key Frame N−1 470 conditioned on a warped frame N to N−1 480, text description input 430 and the HD map 440. Likewise, a diffusion network 460 generates Key Frame N 490 conditioned on the text description input 430 and HD map 440. The masked RGBD input 340 from training can be blocked out by setting this input as all masked.

The Key Frame N−1 470 is generated at viewpoint N−1, and is generated by the diffusion network 450. Warp frame N to N−1 480 employs the depth generated in Key Frame N 490. The warp frame N to N−1 480 is inputted as a control signal for the diffusion network 450 to ensure 3D consistency between Key Frame N−1 470 and Key Frame N 490.

Key Frame N−1 470 is a key frame generated at viewpoint N−1 by the diffusion network 450. The warp frame N to N−1 i480 provides the depth generated in Key Frame N 490. Key Frame N 490 is a key frame generated at viewpoint N by diffusion network 460. The diffusion network 450 and the diffusion network 460 can be the same or different diffusion networks. These networks can share node weights of the neural network.

In the interpolating framework 550, in a warped frame to middle frame block 500, points generated in Key Frame N−1 470 and Key Frame N 480 are projected to any frames in the middle frame. The projections are inputted to a diffusion network 510 for generating the middle frame 520. The diffusion network 510 can be generated by taking the text description input 430 and the HD map 440. The middle frame 520 is generated between Key Frame N 490 and Key Frame N−1 490) as generated by the diffusion network 510.

A trajectory 435 is also provided showing where the middle frame 520 is generated and its positions along the trajectory. The same process can be applied recursively to generate a plurality of middle frames.

Autonomous simulation provides a safe and cost-efficient method for testing autonomous systems within virtual environments, eliminating potential risks to both human safety and equipment. In the context of autonomous driving simulations, components can be divided into two primary categories: static background (e.g., sky, roads, buildings) and dynamic actors (e.g., vehicles, pedestrians). In an embodiment, systems and methods are described which specifically focus on the simulation of the background, although these system and methods can be applied to any image or scene simulations.

A high-quality background is important for creating realistic environments that enable autonomous systems to accurately interpret road conditions and infrastructure to ensure precise sensor perception, shaping interactions between dynamic objects, and producing effective training data. Approaches to simulating backgrounds generally fall into two categories: reconstruction-based methods, e.g., NeRF, and generation-based methods, such as video diffusion. NeRF methods need high-quality inputs, including videos, poses, and sometimes Lidar data. Video diffusion methods often struggle to generate 3D-consistent and long-range content due to their lack of 3D priors.

A framework is provided for long-range background generation that enhances 3D consistency by incorporating explicit 3D geometry through depth maps. The core of a diffusion-based framework is the RGBD model, capable of generating both RGB images and depth maps. This model leverages various input conditions, including warped RGBD, maps, and bounding box information, to generate a 3D scene by integrating iterative outpainting and interpolation processes. A warp consistent loss is introduced for enhancing the consistency between input and generation results. Additionally, to improve the autoregressive generation performance, an iterative outpainting training pipeline is provided.

The present embodiments include an RGBD diffusion network and a novel autoregressive video generation pipeline. The RGBD diffusion network integrates multiple conditioning inputs, including text, HD map, and a masked RGBD image, to generate a comprehensive RGBD output. This RGBD image comprises an RGB image combined with a depth map. Different network architectures can be employed for RGBD generation.

In one architecture, RGB and depth information are combined into a 4-channel RGBD image, which is compressed with a VAE and then undergoes diffusion generation through a U-Net. Another architecture, processes RGB and depth separately within a dual-stream framework. Specifically, two distinct U-Nets handle RGB and depth independently, with multiple cross-attention layers introduced to improve coherence between the two streams. In the depth branch, the depth channel is expanded from 1 to 3 by replicating the depth map to match the RGBD shape. Additionally, the U-Nets for RGB and depth share weights to enhance generalizability.

While the first architecture can be more efficient, the second architecture offers greater capacity, better leveraging the diffusion priors trained on extensive datasets. In both architectures, conditions are input at each diffusion step via a control net to strengthen adherence to these conditions. Notably, this framework supports the generation of images conditioned only on text and the HD map by utilizing a fully masked RGB image as input. To train this network, we compiled a dataset of 11 million images from diverse sources, including NuScenes, Argoverse 2, SA-1B, and SODA IOM. Text captions were generated using Lucy, while depth predictions were obtained via Metric3D v2.

While the RGBD diffusion network focuses on image generation, its capabilities are extended to video generation by incorporating it into an autoregressive video generation pipeline. This pipeline begins by sampling a set of sparse viewpoints along a defined trajectory. Subsequently, in the outpainting stage, it generates “key frames” at these viewpoints. Intermediate frames between adjacent key frames are generated in the interpolation stage.

For clarity, a viewpoints index is employed herein from a start to an end of a trajectory as 1 to N. In the outpainting stage, we begin at viewpoint N and generate “key frame N” conditioned only on text and HD map. Given that the background of driving scenes typically consists of static elements such as roads, buildings, and traffic signals, we assume a static background. This assumption allows us to warp key frame N back to viewpoint N−1 based on the depth map. The warped image serves as a partially masked image at viewpoint N−1, where part of the image has been observed in “key frame N” and is thus available, while the other part contains unknown new content. We then utilize the diffusion network to generate the new content by conditioning on this warped RGBD frame, HD map, and text to produce key frame N−1. This process is conducted iteratively until frame 1, generating all key frames.

In the interpolation stage, we generate frames between viewpoint X (0<X<N−1) and X+1 by warping the points from X and X+1 to the intermediate frames, forming a masked input image. For the interpolation stage, we employ a video diffusion network conditioned on first, last frame and interpolated masked input image to generate the simulation results. In both outpainting and interpolation stages, the generation is conditioned on the geometry and appearance of the generated frame through warping and inpainting. This approach ensures that the generated video exhibits 3D consistency.

The iterative generation pipeline poses a significant challenge to the consistency of generated keyframes. Failure to maintain consistency can lead to physically inaccurate simulations and degrade interpolation performance. To address this, we introduce a warp-consistent loss to improve the outpainting technique's consistency. This loss minimizes the distance between the generated results and the warp conditions in the overlapping regions and can be applied both during training and inference to guide the diffusion process towards enhanced consistency.

Additionally, to address decay issues in the autoregressive generation process, where errors accumulate and amplify as the number of iterations increases, we developed a training strategy that simulates the iterative outpainting process. Specifically, we generate M images iteratively during training, enforcing similarity with the corresponding ground truth for each iteration.

The present embodiments provide novel RGBD diffusion networks, which accommodate multiple control signals to generate both appearance and geometry in RGBD images. A new autoregressive video generation pipeline leverages the RGBD diffusion network to produce extended, 3D-consistent driving scenes. Additionally, a warp-consistent loss is introduced to improve generation quality. An iterative training method has been devised to enhance the performance of the outpainting process across successive iterations.

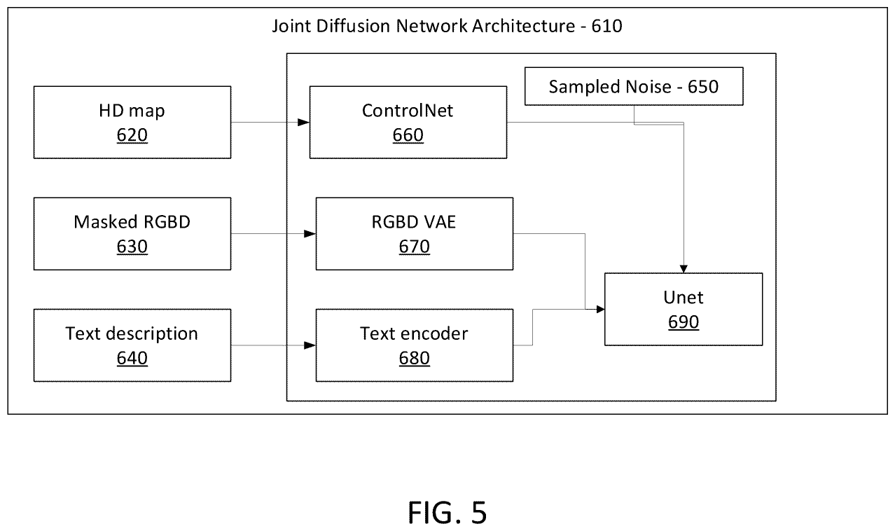

Referring to FIG. 5, a joint RGBD diffusion network architecture 610 is shown in accordance with an embodiment. The diffusion network architecture 610 combines RGB and depth information into a 4-channel RGBD image, which is compressed with a RGBD VAE 670 and then undergoes diffusion generation through a Unet 690. The joint RGBD diffusion network 610 takes an HD map 620 as a control signal, takes a masked RGBD input 630 as a control signal and a text description as input. ControlNet 660 receives the HD map 620 as a control signal to process the control signal. The control signal is subjected to random sampled noise 650 from, e.g., a gaussian distribution. The Unet 690 takes the control signal subjected to random sampled noise 650 at the start of the diffusion process. The RGBD VAE 670 compresses the masked RGBD input 630, which is the concatenation of RGB images and their depth map. A text encoder 680 (e.g., using CLIP) encodes the text description 640, the generated feature is input to Unet 690.

The Unet 690 receives the control signal (from the HD map 620) subjected to random sampled noise 650 as well as input from the RGBD VAE 670 and the text encoder 680 to generate and output the Unet 690.

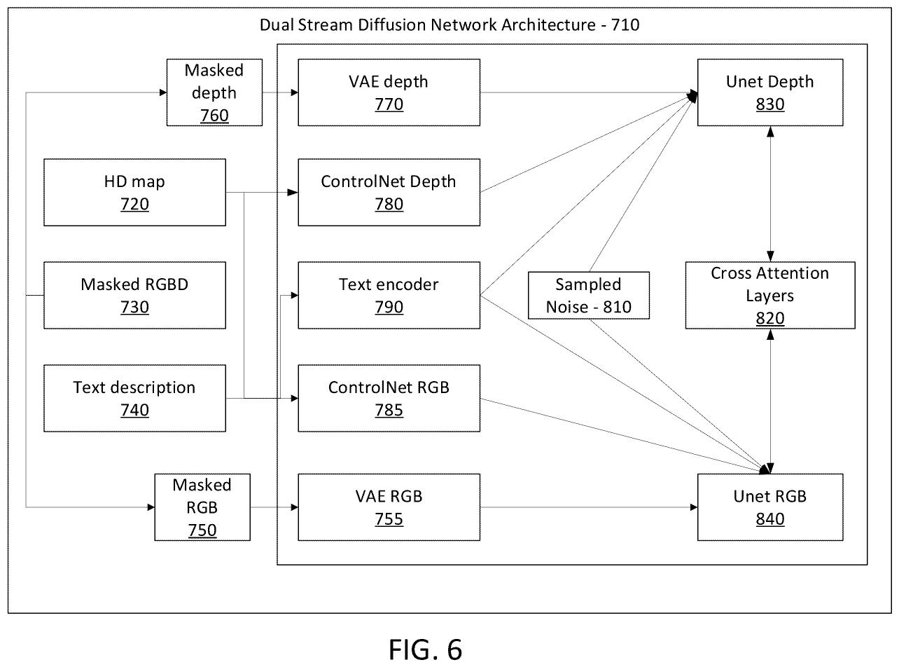

Referring to FIG. 6, another architecture, processes RGB and depth separately within a dual-stream framework. Specifically, two distinct Unets handle RGB and depth independently, with multiple cross-attention layers introduced to improve coherence between the two streams. In the depth branch, the depth channel is expanded from 1 to 3 by replicating the depth map to match the RGBD shape. Additionally, the Unets for RGB and depth share weights to enhance generalizability.

A dual stream diffusion network 710 takes an HD map 720 as a control signal, takes a masked RGBD input 730 as a control signal and takes a text description 740 as an input. The masked RGBD input 730 is separated into a masked RGB input 750 (RGB part) and a masked depth input 760 (depth part). This is extended to 3 channels by replicating the depth map to match the RGBD shape.

A VAE depth module 770 compresses the masked depth input 760. A VAE RGB module 755 compresses the masked RGB input 750. A ControlNet depth module 780 processes the control signal for a depth stream. A ControlNet RGB module 785 processes the control signal for an RGB stream. A text encoder 790 encodes the text description 740. A CLIP encoder can be employed for the text encoder 790.

Random sampled noise 810 can be provided to both streams and random noise sampled from, e.g., a gaussian distribution, can be provided as input to Unet depth 830 and Unet RGB 840 to start the diffusion process.

Cross attention layers 820 ensure information exchange between the RGB stream and the depth stream. The Unet depth 830 takes input from VAE depth 770 ControlNet depth 780, text encoder 790 and random sampled noise 810 and generates an output. Likewise, Unet RGB 840 takes input from VAE RGB 755, ControlNet RGB 785, text encoder 790 and random sampled noise 810 and generates an output.

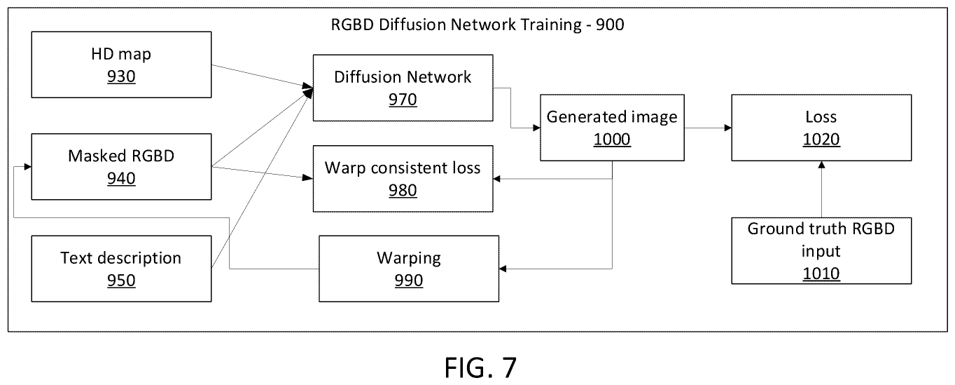

Referring to FIG. 7, a RGBD diffusion network training framework 900 is shown for training an RGBD diffusion model to produce trained diffusion networks 610 (FIG. 5) and 710 (FIG. 6). The model to be trained takes an HD map 930 as a control signal, takes a masked RGBD input 940 as a control signal and takes a text description 950 as an input. Part of the masked RGBD input 940 is warped by a warp consistent loss 980. Another part of the masked RGBD input 940 is warped from ground truth images and depth.

A diffusion network 970 can include, e.g., the diffusion network 610 (FIG. 5) or diffusion network 710 (FIG. 6). The diffusion network 970 generates and outputs a generated image 1000. The warp consistent loss 980 provides a loss to enforce consistency between the masked RGBD input 940 and the generated image 1000 by enforcing the 12 loss on overlapped regions. A warping module 990 warps the generated image 1000 to the RGBD input 940 for iterative training.

A ground truth RGBD input 1010 includes a ground truth image or information to enable comparison and evaluation of loss for feedback. The ground truth RGBD input 1010 is employed for training the diffusion model. A loss 1020 is employed to supervise the training of the diffusion model (e.g., 12 loss is employed). Autoregressive outpainting and interpolation can be employed using the trained diffusion model(s) as described with reference to FIG. 4 to generate middle frames and provide simulated images and/or video for further training autonomous vehicle systems. Autonomous simulation provides a safe and cost-effective way to test autonomous systems in virtual environments, where high-quality scene simulation provides for realistic driving scenarios, accurate sensor perception, and effective training data for scene generation that enhances 3D consistency by incorporating strong geometric priors through prior knowledge, signals and loss functions. Combined with an autoregressive generation pipeline, the present embodiments produce long-horizon, 3D-consistent driving scenes.

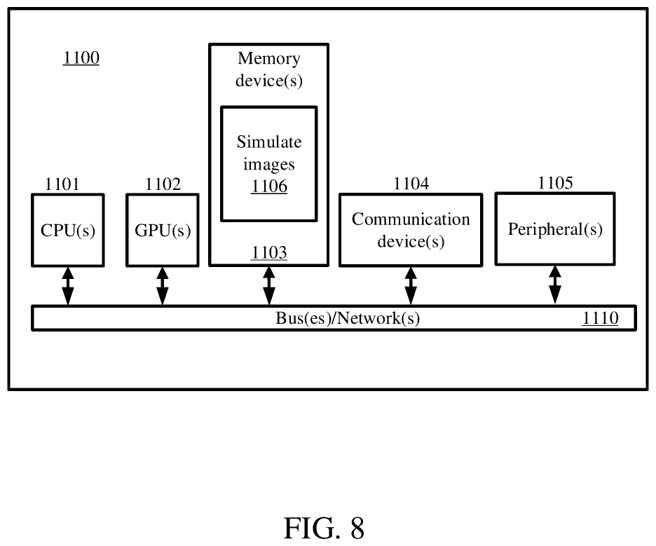

Referring to FIG. 8, a block diagram is shown for an exemplary processing system 1100, in accordance with an embodiment of the present invention. The processing system 1100 can include one or more of a set of processing units (e.g., CPUs) 1101 or a set of GPUs 1102. The processing system 1100 can include a set of memory devices 1103, a set of communication devices 1104, and a set of peripherals 1105. The CPUs 1101 can be single or multi-core CPUs. The GPUs 1102 can be single or multi-core GPUs. The one or more memory devices 1103 can include caches, RAMs, ROMs, and other memories (flash, optical, magnetic, etc.). The communication devices 1104 can include wireless and/or wired communication devices (e.g., network (e.g., WIFI, etc.) adapters, etc.). The peripherals 1105 can include a display device, a user input device, a printer, an imaging device, and so forth. Elements of processing system 1100 are connected by one or more buses or networks (collectively denoted by the figure reference numeral 1110).

In an embodiment, memory devices 1103 can store specially programmed software modules 1106 to transform the computer processing system into a special purpose computer configured to implement various aspects of the present invention. In an embodiment, special purpose hardware (e.g., Application Specific Integrated Circuits, Field Programmable Gate Arrays (FPGAs), and so forth) can be used to implement various aspects of the present invention.

In an embodiment, memory devices 1103 store program code for implementing one or more functions of the systems and methods described herein for synthesizing or simulating images (software modules 1106). The memory devices 1103 can store program code for implementing one or more functions of the systems and methods described herein.

Of course, the processing system 1100 may also include other elements (not shown), as readily contemplated by one of skill in the art, as well as omitting certain elements. For example, various other input devices and/or output devices can be included in processing system 1100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 1100 are readily contemplated by one of ordinary skill in the art given the teachings of the present invention provided herein.

Moreover, it is to be appreciated that various figures as described with respect to various elements and steps relating to the present invention that may be implemented, in whole or in part, by one or more of the elements of system 1100.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid-state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs). These and other variations of a hardware processor subsystem are also contemplated in accordance with embodiments of the present invention.

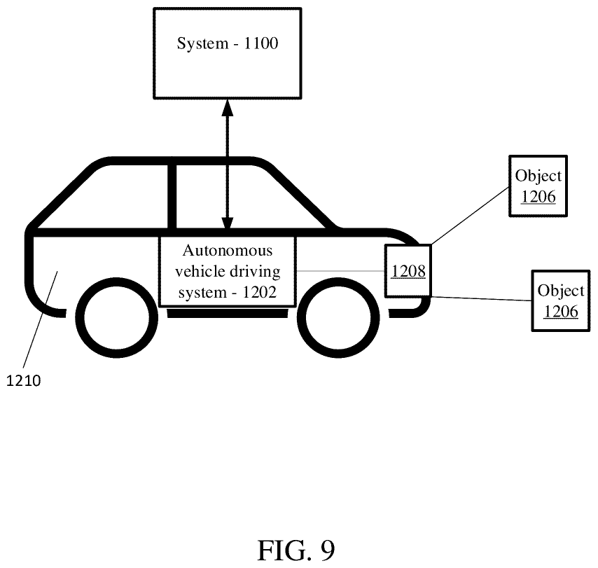

Referring to FIG. 9, embodiments of the present invention can be employed in any number of practical applications. A self-training system that discovers and identifies novel objects can be employed in any computer vision scenario. A self-training system that generates synthesized or simulated images in a perception model can also be employed in any computer vision scenario. These systems can be employed in autonomous driving applications. In an embodiment, a vehicle 1210 can include an autonomous driving system 1202 (e.g., Advanced Driving Assistance System (ADAS)). The autonomous driving system 1202 includes one or more sensors 1208 that are configured to perceive objects 1206 with which the vehicle 1210 will encounter. The autonomous driving system 1202 can employ computer vision to detect the objects and respond by avoiding them.

The autonomous driving system 1202 can interact with or be a part of system 1100, which includes software 1106 (FIG. 8). Software 1106 can detect novel objects and can update a perception model by providing an identity for novel objects. Software 1106 can also determine weakness in the perception model by using as feedback any unknown objects and/or objects that cannot be identified with sufficient accuracy. Software 1106 can be distributed or can exist on the vehicle 1210 or remotely from the vehicle 1210 and be accessible over a network, such as, e.g., the Cloud/internet, etc.

Since the system 1100 is self-training, the system 1100 can be employed concurrently with other functions of the autonomous driving system 1202. For example, while avoiding objects 1206, the system 1100 can be learning at the same time to improve performance by synthesizing images for training. In addition, perception models can be improved by using the novel objects to determine any deficiencies in the models' ability to correctly predict objects.

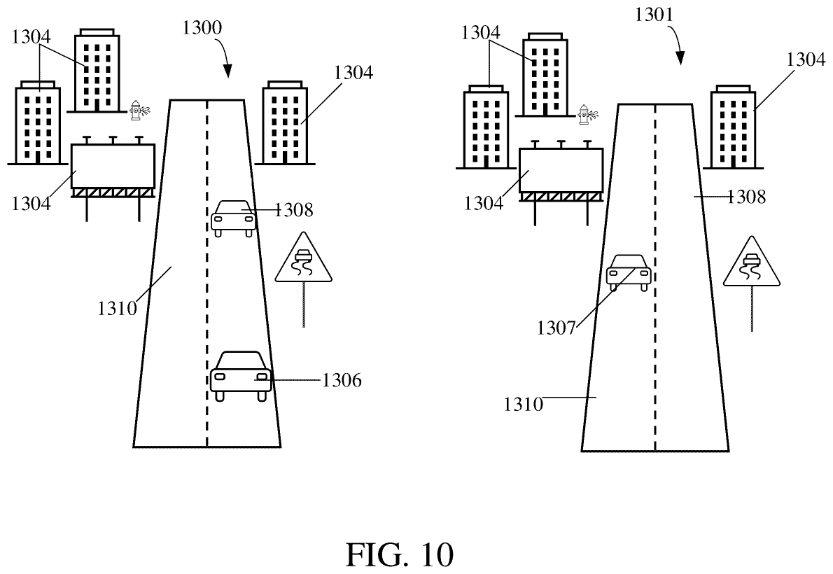

FIG. 10 shows an example of a synthesized image generated in accordance with systems described herein. A scene of a reference image 1300 includes buildings 1304 or other structures and a number of vehicles 1306 and 1308, which can be in motion. A synthesized image 1301 generated in accordance with the present embodiments includes images of a vehicle 1307 that accounts for depth to accurately portray a realistic image of static objects, dynamic objects and accurately accounts for the sky background. Here, the vehicle 1307 is generated on the left side of a road 1310 at a different depth when compared to the vehicles 1306, 1308 of the reference image 1300. By being able to generate synthetic images with accurate depth, model training data can more easily be generated with labels without human interaction.

Synthetic images can be employed for training systems with little human intervention. Synthetic images can enable self-training and help to account for novel occurrences and objects in a scene.

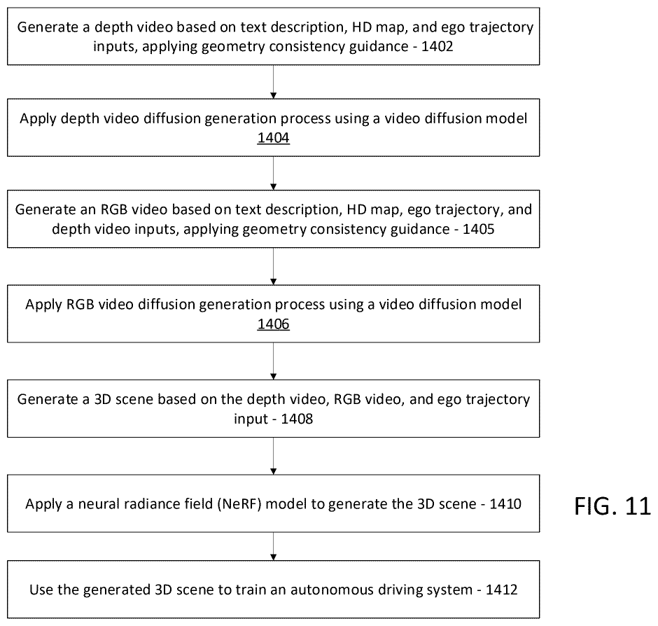

Referring to FIG. 11, a method for generating a three-dimensional (3D) scene is described. In block 1402, a depth video is generated based on a text description input, an HD map input, and an ego trajectory input wherein geometry consistency guidance is applied to enforce geometry consistency in the depth video. In block 1404, the depth video generation can include applying a depth video diffusion generation process to the text description input, the HD map input, and the ego trajectory input. The depth video diffusion generation process can employ a video diffusion model.

In block 1404, an RGB video is generated based on the text description input, the HD map input, the ego trajectory input, and the depth video wherein geometry consistency guidance is applied to enforce geometry consistency in the RGB video. In block 1406, the RGB video generation can include applying an RGB video diffusion generation process to the text description input, the HD map input, the ego trajectory input, and the depth video. The RGB video diffusion generation process can employ a video diffusion model.

In block 1408, a 3D scene is generated based on the depth video, the RGB video, and the ego trajectory input. In block 1410, the 3D scene generation can include applying a neural radiance field (NeRF) model to the depth video, the RGB video, and the ego trajectory input. In block 1412, the 3D scene can be generated and employed to train an autonomous driving system.

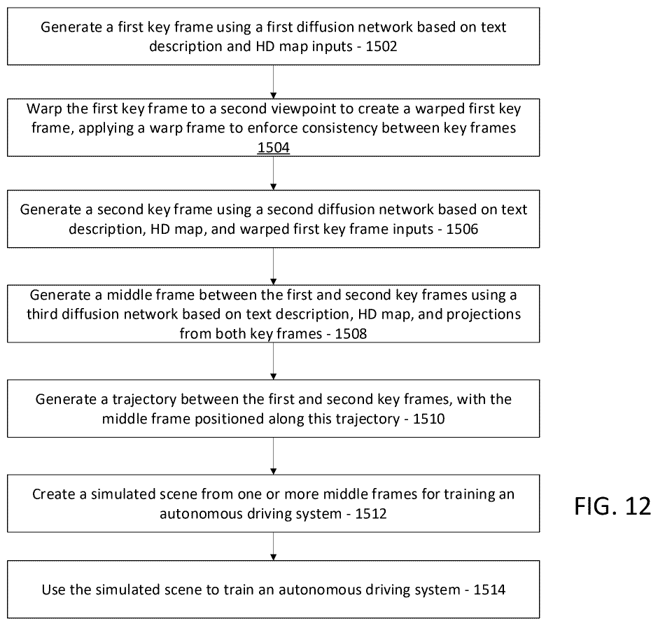

Referring to FIG. 12, another method for generating a simulated scene is described. In block 1502, a first diffusion network generates a first key frame based on a text description input and a high definition (HD) map input. In block 1504, the first key frame is warped to a second viewpoint (provided a warped first key frame). A warp frame is applied to enforce consistency between the first key frame and the second key frame.

In block 1506, a second diffusion network generates a second key frame based on the text description input, the HD map input, and the warped first key frame. In block 1508, a third diffusion network generates a middle frame between the first key frame and the second key frame based on the text description input, the HD map input, and projections from the first key frame and the second key frame.

The first diffusion network, the second diffusion network, and the third diffusion network can include red, green, blue, depth (RGBD) diffusion networks. The first diffusion network, the second diffusion network, and the third diffusion network can share weights in their respective neural networks.

In block 1510, a trajectory can be generated between the first key frame and the second key frame, wherein the middle frame is generated at a point along the trajectory.

In block 1512, the simulated scene can be generated from one or more middle frames to train an autonomous driving system. In block 1514, the simulated scene is employed to train an autonomous driving system.

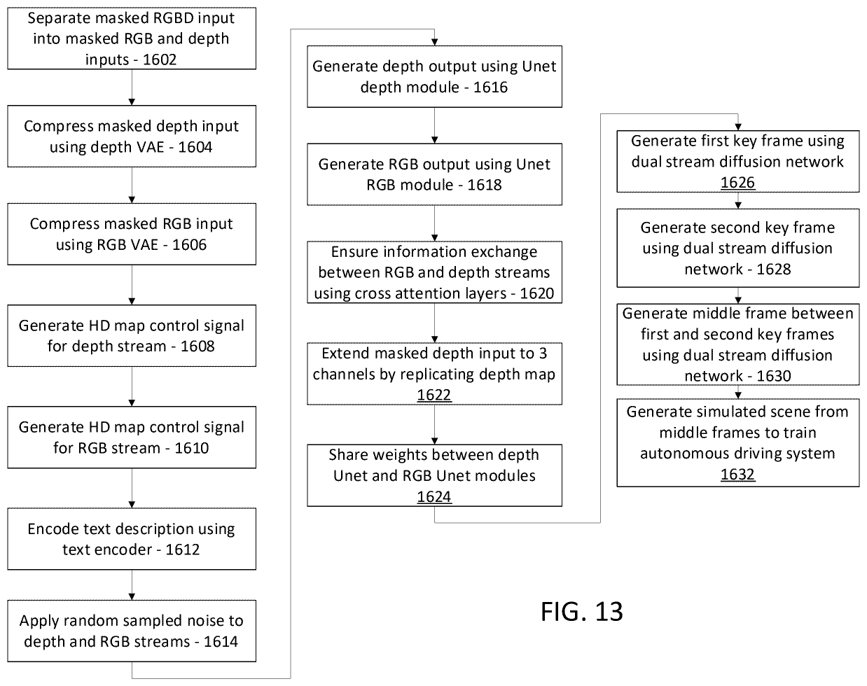

Referring to FIG. 13, another method for generating a generating three-dimensional (3D) scene is described. In block 1602, a masked RGBD input is separated into a masked RGB input and a masked depth input. In block 1604, the masked depth input is compressed using a depth variational autoencoder (VAE). In block 1606, the masked RGB input is compressed using an RGB VAE. In block 1608, an HD map control signal is generated for a depth stream. In block 1610, an HD map control signal is generated for an RGB stream. In block 1612, a text description is encoded using a text encoder. In block 1614, random sampled noise is applied to both the depth stream and the RGB stream. In block 1616, a depth output is generated using a Unet for depth based on inputs from the depth VAE, the HD map control signal for the depth stream, text encoder, and random sampled noise. In block 1618, an RGB output is generated using an RGB Unet based on inputs from the RGB VAE module, the HD map control signal for an RGB stream, text encoder, and random sampled noise to train a dual stream diffusion network.

In block 1620, the dual stream diffusion network includes cross attention layers configured to ensure information exchange between the RGB stream and the depth stream. In block 1622, the masked depth input can be extended to 3 channels by replicating a depth map to match the masked RGBD input shape. In block 1624, the depth Unet and the RGB Unet module can share weights.

A dual stream diffusion network can be employed in generating a first key frame based on a text description input and an HD map input, in block 1626; generating a second key frame based on the text description input, the HD map input, and a warped first key frame, in block 1628; and generating a middle frame between the first key frame and the second key frame based on the text description input, the HD map input, and projections from the first key frame and the second key frame, in block 1630.

In block 1632, a simulated scene can be generated from one or more middle frames to train an autonomous driving system.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A system for generating three-dimensional (3D) scenes, comprising:
a memory storing instructions; and
a processor configured to execute the instructions to:
separate a masked red, green, blue, depth (RGBD) input into a masked RGB input and a masked depth input;
compress the masked depth input;
compress the masked RGB input;
generate a high definition (HD) map control signal for a depth stream;
generate a HD map control signal for an RGB stream;
encode a text description using a text encoder;
apply random sampled noise to both the depth stream and the RGB stream;
generate a depth output based on inputs from the depth stream, the HD map control signal for the depth stream, text encoder, and random sampled noise; and
generate an RGB output based on inputs from the RGB stream, the HD map control signal for an RGB stream, text encoder, and random sampled noise to train a dual stream diffusion network.

2. The system of claim 1, wherein the dual stream diffusion network further comprises cross attention layers configured to ensure information exchange between the RGB stream and the depth stream.

3. The system of claim 1, wherein the masked depth input is extended to 3 channels by replicating a depth map to match a shape of the masked RGBD input.

4. The system of claim 1, wherein the depth output and the RGB output are generated by Unets that share weights.

5. The system of claim 1, wherein the random sampled noise is sampled from a gaussian distribution.

6. The system of claim 1, wherein the dual stream diffusion network is employed to: generate a first key frame based on a text description input and an HD map input;
generate a second key frame based on the text description input, the HD map input, and a warped first key frame; and
generate a middle frame between the first key frame and the second key frame based on the text description input, the HD map input, and projections from the first key frame and the second key frame.

7. The system of claim 6, further comprising:
generating a simulated scene from one or more middle frames to train an autonomous driving system.

8. A method for generating three-dimensional (3D) scenes, comprising:
separating a masked red, green, blue, depth (RGBD) input into a masked RGB input and a masked depth input;
compressing the masked depth input;
compressing the masked RGB input;
generating a high definition (HD) map control signal for a depth stream;
generating a HD map control signal for an RGB stream;
encoding a text description using a text encoder;
applying random sampled noise to both the depth stream and the RGB stream;
generating a depth output based on inputs from the depth stream, the HD map control signal for the depth stream, text encoder, and random sampled noise; and
generating an RGB output based on inputs from the RGB stream, the HD map control signal for an RGB stream, text encoder, and random sampled noise to train a dual stream diffusion network.

9. The method of claim 8, wherein the dual stream diffusion network further comprises cross attention layers configured to ensure information exchange between the RGB stream and the depth stream.

10. The method of claim 8, wherein the masked depth input is extended to 3 channels by replicating a depth map to match a shape of the masked RGBD input.

11. The method of claim 8, wherein the depth output and the RGB output are generated by Unets that share weights.

12. The method of claim 8, wherein the random sampled noise is sampled from a gaussian distribution.

13. The method of claim 8, further comprising, by the dual stream diffusion network:
generating a first key frame based on a text description input and an HD map input;
generating a second key frame based on the text description input, the HD map input, and a warped first key frame; and
generating a middle frame between the first key frame and the second key frame based on the text description input, the HD map input, and projections from the first key frame and the second key frame.

14. The method of claim 13, further comprising:
generating a simulated scene from one or more middle frames to train an autonomous driving system.

15. A non-transitory computer-readable medium storing instructions that, when executed by a processor, cause the processor to perform a method, the method comprising:
separating a masked red, green, blue, depth (RGBD) input into a masked RGB input and a masked depth input;
compressing the masked depth input;
compressing the masked RGB input;
generating a high definition (HD) map control signal for a depth stream;
generating a HD map control signal for an RGB stream;
encoding a text description using a text encoder;
applying random sampled noise to both the depth stream and the RGB stream;
generating a depth output based on inputs from the depth stream, the HD map control signal for the depth stream, text encoder, and random sampled noise; and
generating an RGB output based on inputs from the RGB stream, the HD map control signal for an RGB stream, text encoder, and random sampled noise to train a dual stream diffusion network.

16. The non-transitory computer-readable medium of claim 15, wherein the dual stream diffusion network further comprises cross attention layers configured to ensure information exchange between the RGB stream and the depth stream.

17. The non-transitory computer-readable medium of claim 15, wherein the depth output and the RGB output are generated by Unets that share weights.

18. The non-transitory computer-readable medium of claim 15, wherein the random sampled noise is sampled from a gaussian distribution.

19. The non-transitory computer-readable medium of claim 15, further comprising, by the dual stream diffusion network:
generating a first key frame based on a text description input and an HD map input;
generating a second key frame based on the text description input, the HD map input, and a warped first key frame; and
generating a middle frame between the first key frame and the second key frame based on the text description input, the HD map input, and projections from the first key frame and the second key frame.

20. The non-transitory computer-readable medium of claim 19, further comprising:
generating a simulated scene from one or more middle frames to train an autonomous driving system.
